(19) United States
(12) Patent Application Publication
(10) Pub. No.: US 2024/0131648 A1
(43) Pub. Date: Apr. 25, 2024

(54) MACHINE TOOL CONTROL DEVICE

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 18/567,178

(22) PCT Filed: Jun. 21, 2021
(86) PCT No.: PCT/JP2021/023589

§ 371 Date: Dec. 5, 2023

(51) Int. Cl. B23Q 15/12

(52) U.S. Cl. CPC B23Q 15/12

(57) ABSTRACT

The present invention is to provide a control device for a machine tool that performs oscillating cutting and that enables loads on a machine tool to be versatilely reduced without depending on the configuration of the machine tool. The present invention provides a control device 1 for a machine tool that performs oscillating cutting by causing a tool T and a workpiece W to oscillate relative to each other, the control device 1 including a cutting edge angle acquiring unit 12 that acquires a cutting edge angle θ1 of the machine tool T, an oscillating amplitude calculating unit 13 that calculates an oscillating amplitude required for chipping in any oscillating direction on the basis of the cutting edge angle θ1 of the tool T, an oscillating direction determining unit 14 that determines an oscillating direction on the basis of a calculation result from the oscillating amplitude calculating unit 13, and an oscillating operation control unit 15 that controls, on the basis of machining conditions, an oscillating operation in the oscillating direction determined by the oscillating direction determining unit 14.

### TECHNICAL FIELD

The present disclosure relates to a control device for a machine tool.

### BACKGROUND ART

Conventionally, it has been known that chips continuously caused in cutting of a workpiece with a cutting tool entangle in the cutting tool and cause machining defects or machine tool breakdown, for example. On this point, oscillation cutting in which the chips are shredded by cutting during relative oscillation of the cutting tool and the workpiece has been proposed. Normally, in oscillation cutting, the cutting tool and the workpiece oscillate relative to each other in a direction along a machining course.

For example, in a case where the workpiece has a tapered shape or an arc shape, there are a plurality of feed axes (e.g., Z-axis and X-axis) for feeding the cutting tool or the workpiece in the direction along the machining course. In this case, oscillation is made simultaneously along the plurality of axes, and for this reason, a burden on the machine tool is great. For this reason, a technique of reducing, by changing an oscillation direction from the direction along the machining course to a different direction at, e.g., a tapered portion of the workpiece, the burden on the machine tool while shredding the chips has been proposed (e.g., see Patent Document 1).

FIG. 7 is a view showing one example of conventional oscillation cutting. In this example, cutting is performed in a feed direction along the generatrix of the outer peripheral surface of a workpiece W rotating about a main axis S while a tool T is moving along a feed axis. In a case of cutting a tapered portion W1 of the workpiece W with the tool T as shown in FIG. 7, the oscillation direction is changed, between a current pass and a previous pass, from the direction along the machining course to a different direction. For example, the oscillation direction along the machining course as indicated by a black arrow in FIG. 7 is changed to the oscillation direction which is the different direction in which an oscillation component in the Z-axis direction increases as an oscillation component in the X-axis direction decreases as indicated by a white arrow.
Patent Document 1: Japanese Patent No. 6763917

### DISCLOSURE OF THE INVENTION

### Problems to be Solved by the Invention

However, in the example shown in FIG. 7, by the change in the oscillation direction, the oscillation component in the Z-axis direction increases as the oscillation component in the X-axis direction decreases. Thus, the burden on the machine tool can be sufficiently reduced in a case where the inertia of the machine tool in the X-axis direction is extremely greater than the inertia in the Z-axis direction. That is, in the above-described conventional oscillation cutting, an effect of reducing the burden on the machine tool depends on the configuration of the machine tool.

Thus, there has been a demand for a versatile technique of reducing, in a control device for a machine tool that performs oscillation cutting, a burden on the machine tool regardless of the configuration of the machine tool.

### Means for Solving the Problems

One aspect of the present disclosure is a control device for a machine tool for performing oscillation cutting by relative oscillation of a tool and a workpiece, the control device including a cutting edge angle acquisition unit that acquires the cutting edge angle of the tool, an oscillation amplitude calculation unit that calculates, based on the cutting edge angle of the tool, an oscillation amplitude necessary for chip shredding in an arbitrary oscillation direction, an oscillation direction determination unit that determines an oscillation direction based on a calculation result of the oscillation amplitude calculation unit, and an oscillation control unit that controls, based on machining conditions, oscillation in the oscillation direction determined by the oscillation direction determination unit.

### Effects of the Invention

According to the present disclosure, the versatile technique of reducing, in the control device for the machine tool that performs oscillation cutting, the burden on the machine tool regardless of the configuration of the machine tool can be provided.

### BRIEF DESCRIPTION OF THE DRAWINGS

FIG. 1 is a diagram showing a control device for a machine tool according to an embodiment of the present disclosure;

FIG. 2 is a view showing the cutting edge angle of a tool;

FIG. 3 is a view showing a method for calculating an oscillation amplitude;

FIG. 4 is a view showing a first example of oscillation cutting according to the present embodiment;

FIG. 5 is a view showing a second example of oscillation cutting according to the present embodiment;

FIG. 6 is a view showing a third example of oscillation cutting according to the present embodiment; and

FIG. 7 is a view showing one example of conventional oscillation cutting.

### PREFERRED MODE FOR CARRYING OUT THE INVENTION

Hereinafter, an embodiment of the present disclosure will be described in detail with reference to the drawings.

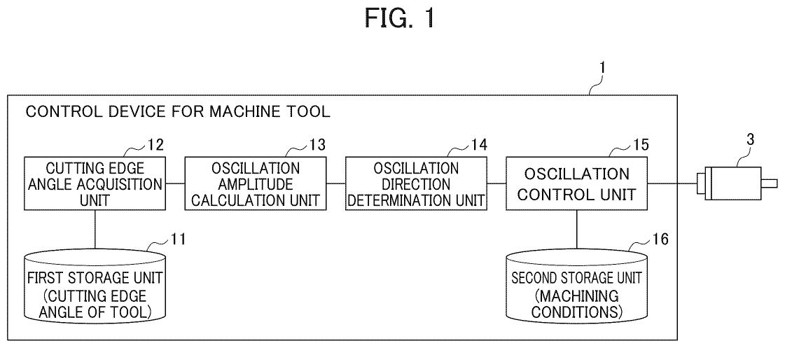

FIG. 1 is a diagram showing a control device 1 for a machine tool according to the present embodiment. The control device 1 for the machine tool according to the present embodiment controls a cutting tool (hereinafter, tool) to cut a workpiece by operating at least one main axis for rotating the tool and the workpiece relative to each other and at least one feed axis for moving the tool relative to the workpiece. Note that for the sake of convenience, FIG. 1 only shows a motor 3 that drives one feed axis.

The control device 1 for the machine tool according to the present embodiment operates the main axis and the feed axis, thereby performing oscillation cutting. That is, the control device 1 for the machine tool oscillates the tool and the workpiece relative to each other while rotating the tool and the workpiece relative to each other, thereby performing cutting. A tool course which is a tool path is set such that a current course partially overlaps with a previous course and a portion machined on the previous course is included in the current course. Thus, by air cutting in which a blade edge of the tool is apart from a surface of the workpiece, chips continuously caused due to cutting are reliably shredded.

The control device 1 for the machine tool is configured, for example, using a computer including a memory such as a read only memory (ROM) or a random access memory (RAM), a control processing unit (CPU), and a communication control unit, these components of the computer being connected to each other via a bus. As shown in FIG. 1, the control device 1 for the machine tool includes a first storage unit 11, a cutting edge angle acquisition unit 12, an oscillation amplitude calculation unit 13, an oscillation direction determination unit 14, an oscillation control unit 15, and a second storage unit 16, and the function and operation of each unit may be implemented by cooperation of the CPU and memory installed in the above-described computer and a control program stored in the memory.

A higher-level computer (not shown) such as a computer numerical controller (CNC) or a programmable logic controller (PLC) is connected to the control device 1 for the machine tool. From such a higher-level computer, not only a machining program but also machining conditions such as a rotation speed and a feed speed and oscillation conditions such as an oscillation frequency are input to the control device 1 for the machine tool.

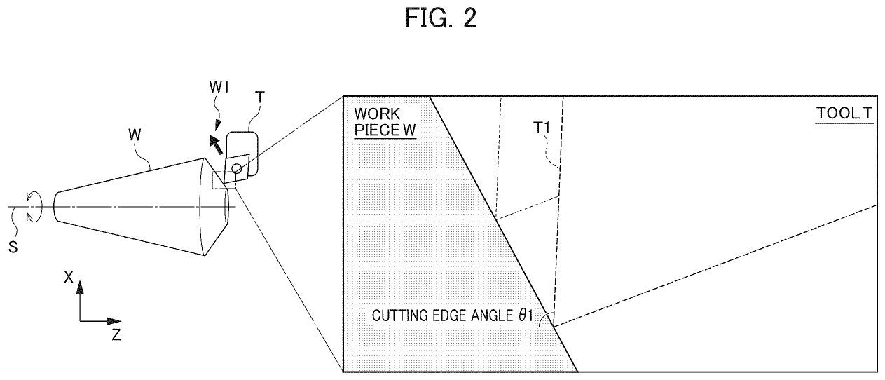

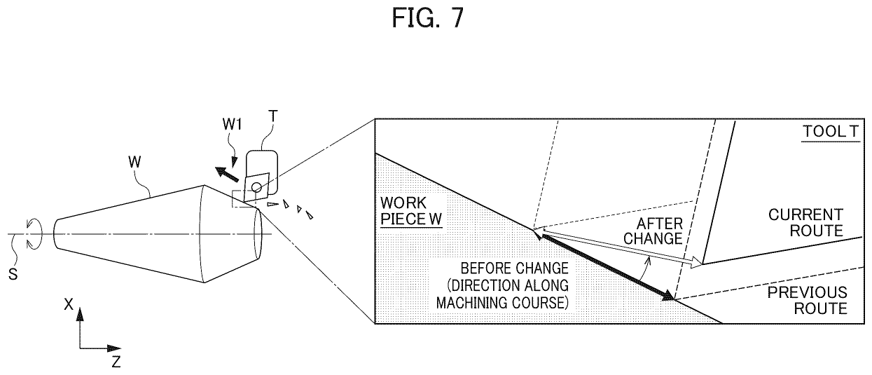

The first storage unit 11 stores the cutting edge angle of the tool. FIG. 2 is a view showing the cutting edge angle θ1 of the tool T. Note that any of FIGS. 2 to 6 described later shows an example where cutting is performed in a feed direction along the generatrix of the outer peripheral surface of a workpiece W rotating about a main axis S while a tool T is moving along a feed axis. Note that the present embodiment is not limited to such outer diameter machining and is also applicable to inner diameter machining. The present embodiment is also applicable to a configuration in which the tool T rotates about the center axis of the workpiece W while the workpiece W is being moved in the feed direction relative to the tool T. Note that in FIGS. 2 to 7, the center axis of the workpiece W is a Z-axis and a direction perpendicular to the Z-axis is an X-axis.

As shown in FIG. 2, the cutting edge angle θ1 of the tool T means an angle between the Z-axis direction which is the center axis direction of the workpiece W and the flank surface T1 of the tool T. The flank surface T1 of the tool T means a workpiece-W-side surface of the blade edge of the tool T in a machining direction (see a black arrow in FIG. 2). The cutting edge angle θ1 is set to a desired angle in advance for each of a plurality of tools T, and does not depend on the taper angle of a machining surface. More specifically, the cutting edge angle θ1 set in advance for each tool T is stored in association with each tool T in the first storage unit.

The cutting edge angle acquisition unit 12 acquires the cutting edge angle θ1 of the tool T. Specifically, the cutting edge angle acquisition unit 12 reads and acquires, based on tool data acquired from the machining program input to the control device 1 for the machine tool, the cutting edge angle θ1 corresponding to the tool from the first storage unit 11. The acquired cutting edge angle θ1 of the tool T is output to the later-described oscillation amplitude calculation unit 13.

The oscillation amplitude calculation unit 13 calculates, based on the cutting edge angle θ1 of the tool T acquired by the cutting edge angle acquisition unit 12, an oscillation amplitude necessary for chip shredding in an arbitrary oscillation direction. The calculated oscillation amplitude in each oscillation direction is output to the later-described oscillation direction determination unit 14 and the later-described oscillation control unit 15. Note that the oscillation amplitude in the present embodiment includes not only the oscillation amplitude itself, but also an oscillation amplitude multiplying factor.

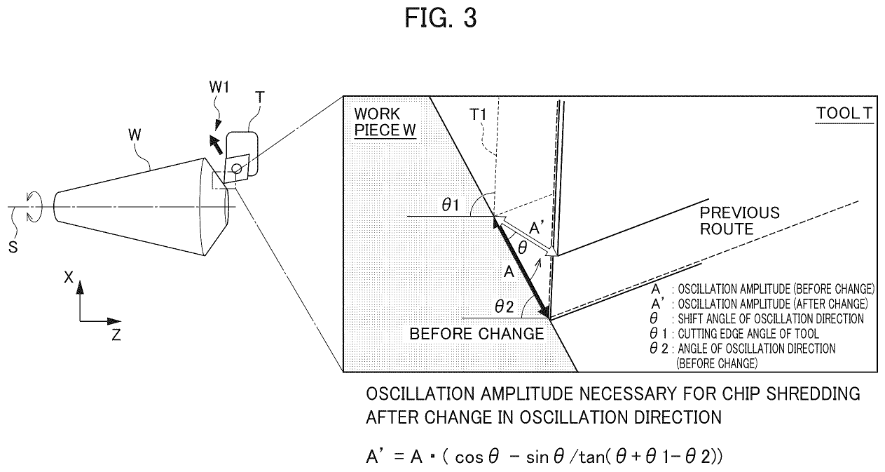

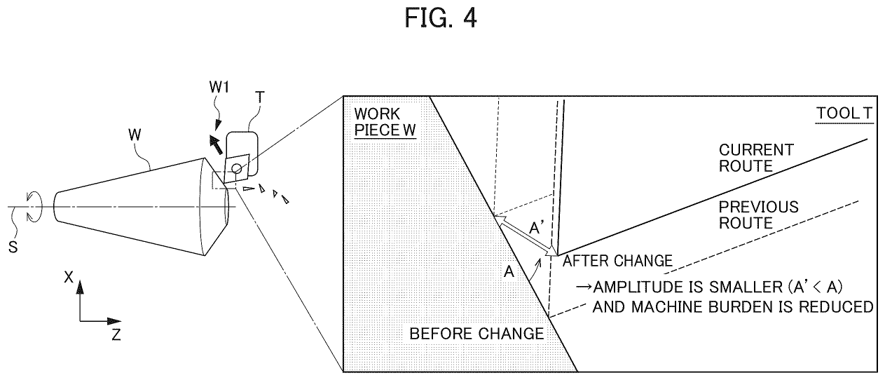

FIG. 3 is a view showing a method for calculating the oscillation amplitude by the oscillation amplitude calculation unit 13. For the sake of convenience in description, FIG. 3 shows a state of making oscillation in a direction along a machining course as in a conventional case as “BEFORE CHANGE” and a state of making oscillation in an arbitrary oscillation direction different from the direction along the machining course as “AFTER CHANGE” (the same also applies to FIGS. 4 to 7). As shown in FIG. 3, an oscillation amplitude A′ necessary for chip shredding in the oscillation direction after the change in the oscillation direction is calculated according to Equation (1) below using an oscillation amplitude A necessary for conventional chip shredding in the oscillation direction along the machining course before the change, a shift angle θ of the oscillation direction between before and after the change, the cutting edge angle θ1 of the tool T, and the angle θ2 between the conventional oscillation direction along the machining course before the change and the Z-axis direction.

[Equation 1]

A′=A×(cos θ−sin θ/tan(θ+θ1−θ2)) Equation (1)

Note that the oscillation amplitude in the present embodiment means the composite oscillation amplitude of an oscillation amplitude component in the Z-axis direction and an oscillation amplitude component in the X-axis direction. That is, the oscillation amplitude in the present embodiment is a composite oscillation amplitude calculated according to Equation (2) below.

[Equation 2]

Composite Oscillation Amplitude=((Z-Axis Amplitude)²+(X−Axis Amplitude)²)^{1/2} Equation (2)

Referring back to FIG. 1, the oscillation direction determination unit 14 determines the oscillation direction based on the oscillation amplitude calculated by the oscillation amplitude calculation unit 13. Preferably, the oscillation direction determination unit 14 determines, in an oscillation direction range in which the chips are shreddable, the oscillation direction with the oscillation amplitude A′ smaller than the oscillation amplitude A of oscillation in the direction along the machining course. With this configuration, a versatile technique of reducing a burden on the machine tool due to oscillation can be provided.

More specifically, the oscillation direction determination unit 14 determines, as the oscillation direction, a direction in which the composite oscillation amplitude of the oscillation amplitude component in the Z-axis direction and the oscillation amplitude component in the X-axis direction is smaller, as shown in FIG. 3.

More preferably, the oscillation direction determination unit 14 determines, as the oscillation direction, a direction perpendicular to the flank surface T1 of the tool T. In this case, the chip-shreddable oscillation amplitude can be the minimum, and the burden on the machine tool can be minimized during chip shredding.

The second storage unit 16 stores machining conditions for the workpiece W etc. The machining conditions for the workpiece W include, for example, the relative rotation speeds of the workpiece W and the tool T about the center axis of the workpiece W, the relative feed speeds of the tool T and the workpiece W, and a feed axis position command. The second storage unit 16 may store the machining program to be executed by the machine tool, and the CPU in the control device 1 for the machine tool may read, as the machining conditions, the rotation speeds and the feed speeds from the machining program and output the machining conditions to the oscillation control unit 15. For example, the storage unit 16 or a position command generation unit in the later-described oscillation control unit 15 may be provided in the above-described higher-level computer.

The oscillation control unit 15 performs, based on the machining conditions, a control of making oscillation in the oscillation direction determined by the oscillation direction determination unit 14. In order to control oscillation, the oscillation control unit 15 includes various functional units (not shown) such as the position command generation unit, an oscillation command generation unit, a superimposition command generation unit, a learning control unit, and a position/speed control unit.

The position command generation unit reads the machining conditions stored in the second storage unit 16, and generates a position command as a movement command for the motor 3 based on the machining conditions. Specifically, the position command generation unit generates a position command (movement command) for each feed axis based on the relative rotation speeds of the workpiece W and the tool T about the center axis of the workpiece W and the relative feed speeds of the tool T and the workpiece W.

The oscillation command generation unit generates an oscillation command. The oscillation command generation unit may generate the oscillation command from the machining conditions and the oscillation conditions including the oscillation amplitude multiplying factor and an oscillation frequency multiplying factor, or may generate the oscillation command from the oscillation conditions including the oscillation amplitude and the oscillation frequency. Specifically, the oscillation command generation unit generates the oscillation command based on the oscillation amplitude calculated by the oscillation amplitude calculation unit 13 and the oscillation conditions, such as the oscillation frequency, input from the higher-level computer and stored in the second storage unit, for example.

The superimposition command generation unit calculates a position deviation which is a difference between the position command and a position feedback based on position detection on the feed axis by an encoder of the motor 3, and generates a superimposition command by superimposing the oscillation command generated by the oscillation command generation unit on the calculated position deviation. Alternatively, the oscillation command may be superimposed on the position command instead of the position deviation.

The learning control unit calculates a superimposition command compensation amount based on the superimposition command, and compensates the superimposition command by adding the calculated compensation amount to the superimposition command. The learning control unit has a memory, stores, in the memory, an oscillation phase and the compensation amount in association with each other in one or more cycles of oscillation, reads the superimposition command stored in the memory at a timing of being able to compensate a phase lag in oscillation according to the responsiveness of the motor 3, and outputs the superimposition command as the compensation amount. In a case where the oscillation phase associated with the compensation amount to be output is not stored in the memory, the compensation amount to be output may be calculated from a compensation amount associated with an oscillation phase close to the above-described oscillation phase. Generally, the position deviation for the oscillation command increases as the oscillation frequency increases. Thus, the learning control unit performs compensation so that followability to the cyclical oscillation command can be improved.

The position/speed control unit generates, based on the superimposition command after addition of the compensation amount, a torque command for the motor 3 that drives the feed axis, and controls the motor 3 according to the generated torque command. Accordingly, machining is performed while the tool T and the workpiece W are oscillating relative to each other.

Next, oscillation cutting performed by the control device 1 for the machine tool according to the present embodiment will be described in more detail with reference to specific examples.

FIG. 4 is a view showing a first example of oscillation cutting according to the present embodiment. The first example is an example when the oscillation direction with the oscillation amplitude A′ smaller than the oscillation amplitude A of oscillation in the direction along the machining course is determined in the oscillation direction range in which the chips are shreddable. As clearly seen from FIG. 4, since the chip-shreddable oscillation amplitude A′ in the oscillation direction after the change is smaller than the oscillation amplitude A of oscillation in the direction along the machining course, the burden on the machine tool can be reduced.

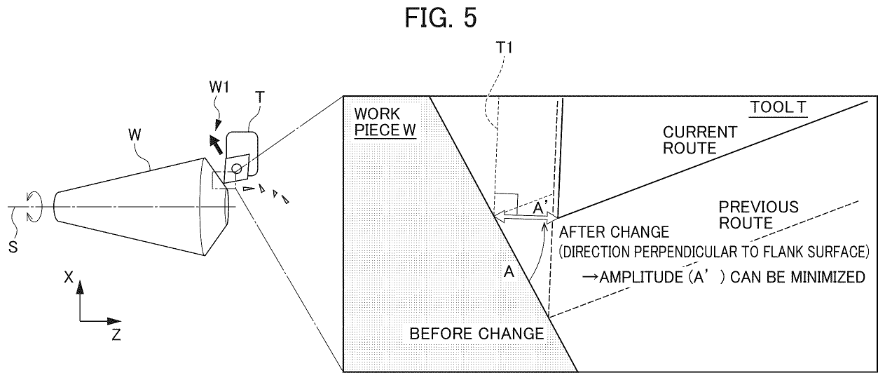

FIG. 5 is a view showing a second example of oscillation cutting according to the present embodiment. The second example is an example when the direction perpendicular to the flank surface T1 of the tool T is determined as the oscillation direction in the oscillation direction range in which the chips are shreddable. As clearly seen from FIG. 5, since the chip-shreddable oscillation amplitude A′ when the direction perpendicular to the flank surface T1 of the tool T is determined as the oscillation direction is much smaller than the oscillation amplitude A of oscillation in the direction along the machining course, the burden on the machine tool can be minimized.

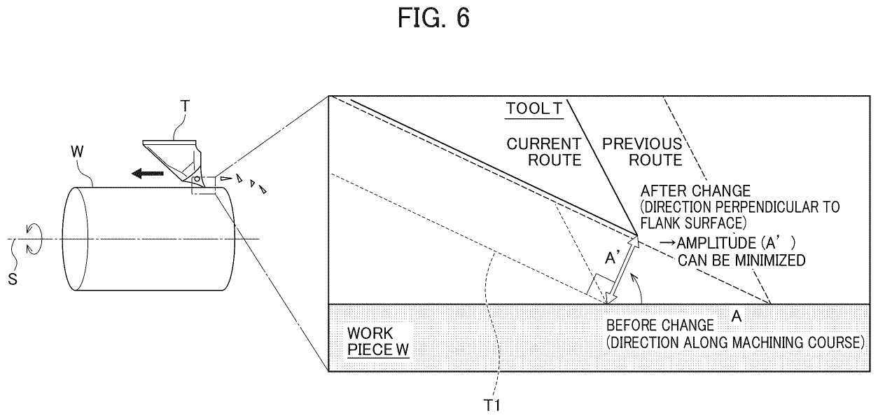

FIG. 6 is a view showing a third example of oscillation cutting according to the present embodiment. The third example is an example when a circular columnar or cylindrical workpiece is used as the workpiece W and the direction perpendicular to the flank surface T1 of the tool T is determined as the oscillation direction in the oscillation direction range in which the chips are shreddable. As clearly seen from FIG. 6, even in a case where the shape of the workpiece W does not have a tapered portion or an arc portion and the feed axis is a specific axis (Z-axis in FIG. 6), the chip-shreddable oscillation amplitude A′ when the direction perpendicular to the flank surface T1 of the tool T is determined as the oscillation direction is much smaller than the oscillation amplitude A of oscillation in the direction along the machining course, and therefore, the burden on the machine tool can be minimized.

As described above, in oscillation cutting according to the present embodiment, the shape of the workpiece W is not limited. That is, the present invention is applicable not only to a case where a plurality of feed axes (Z-axis and X-axis) is necessary because the workpiece W has a tapered portion or an arc portion at the machining surface, but also to a case where a specific feed axis (Z-axis) is enough because the workpiece W has a circular columnar shape or a cylindrical shape. Thus, the oscillation control unit 15 according to the present embodiment changes oscillation along the plurality of feed axes or oscillation along only the specific axis of the plurality of feed axes to oscillation in the oscillation direction determined by the oscillation direction determination unit 14.

According to the present embodiment, the following advantageous effects are provided.

In the present embodiment, the control device 1 for the machine tool includes the cutting edge angle acquisition unit 12 that acquires the cutting edge angle of the tool T, the oscillation amplitude calculation unit 13 that calculates, based on the cutting edge angle of the tool T, the oscillation amplitude necessary for chip shredding in the arbitrary oscillation direction, the oscillation direction determination unit 14 that determines the oscillation direction based on the calculation result of the oscillation amplitude calculation unit 13, and the oscillation control unit 15 that controls, based on the machining conditions, oscillation in the oscillation direction determined by the oscillation direction determination unit 14.

In conventional oscillation cutting, the oscillation direction is determined, and thereafter, the chip-shreddable oscillation amplitude is calculated. On the other hand, in the present embodiment, the chip-shreddable oscillation amplitudes are calculated for the plurality of arbitrary oscillation directions, and thereafter, the oscillation direction is determined based on the calculated oscillation amplitudes. On this point, the conventional oscillation cutting and the present embodiment are greatly different from each other. Thus, according to the present embodiment, the oscillation direction with the oscillation amplitude smaller than the oscillation amplitude of oscillation in the direction along the machining course can be selected and determined, and therefore, the burden on the machine tool can be reduced. Consequently, according to the present embodiment, the versatile technique of reducing the burden on the machine tool regardless of the configuration of the machine tool can be provided.

In the present embodiment, in the oscillation direction range in which the chips are shreddable, oscillation is made in the oscillation direction with the oscillation amplitude smaller than the oscillation amplitude of oscillation in the direction along the machining course. Thus, as compared to conventional oscillation in the direction along the machining course, the burden on the machine tool can be more reliably reduced while the chips are being shredded.

In the present embodiment, oscillation is made in the direction perpendicular to the flank surface T1 of the tool T. Thus, as compared to conventional oscillation in the direction along the machining course, the burden on the machine tool can be more reliably reduced while the chips are being shredded. In addition, the burden on the machine tool can be minimized.

In the present embodiment, the oscillation control unit 15 changes oscillation in only the specific axis of the plurality of feed axes to oscillation in the oscillation direction determined by the oscillation direction determination unit 14. As described above, the present embodiment is applicable not only to the case where the plurality of feed axes (Z-axis and X-axis) is necessary because the workpiece W has the tapered portion or the arc portion at the machining surface, but also to the case where the specific feed axis (Z-axis) is enough because the workpiece W has the circular columnar shape or the cylindrical shape, and the above-described advantageous effects can be provided.

Note that the present disclosure is not limited to the above-described aspects and changes and modifications are also included in the present disclosure without departing from a scope in which the object of the present disclosure can be achieved.

### EXPLANATION OF REFERENCE NUMERALS

1 Control Device for Machine Tool
11 First Storage Unit
12 Cutting Edge Angle Acquisition Unit
13 Oscillation Amplitude Calculation Unit
14 Oscillation Direction Determination Unit
15 Oscillation Control Unit
16 Second Storage Unit
3 Motor
S Main Axis
T Tool
W Workpiece
W1 Tapered Portion
θ1 Cutting Edge Angle

1. A control device for a machine tool for performing oscillation cutting by relative oscillation of a tool and a workpiece, comprising:
a cutting edge angle acquisition unit that acquires a cutting edge angle of the tool;
an oscillation amplitude calculation unit that calculates, based on the cutting edge angle of the tool, an oscillation amplitude necessary for chip shredding in an arbitrary oscillation direction;
an oscillation direction determination unit that determines an oscillation direction based on a calculation result of the oscillation amplitude calculation unit; and
an oscillation control unit that controls, based on a machining condition, oscillation in the oscillation direction determined by the oscillation direction determination unit.

2. The control device for the machine tool according to claim 1, wherein the oscillation direction determination unit determines, in an oscillation direction range in which a chip is shreddable, an oscillation direction with an oscillation amplitude smaller than an oscillation amplitude of oscillation in a direction along a machining course.

3. The control device for the machine tool according to claim 1, wherein the oscillation direction determination unit determines, as the oscillation direction, a direction perpendicular to a flank surface of the tool, which is a workpiece-side surface of a blade edge of the tool in a machining direction.

4. The control device for the machine tool according to claim 1, wherein the oscillation control unit changes oscillation in only a specific axis of a plurality of feed axes to oscillation in the oscillation direction determined by the oscillation direction determination unit.

5. The control device for the machine tool according to claim 2, wherein the oscillation control unit changes oscillation in only a specific axis of a plurality of feed axes to oscillation in the oscillation direction determined by the oscillation direction determination unit.

6. The control device for the machine tool according to claim 3, wherein the oscillation control unit changes oscillation in only a specific axis of a plurality of feed axes to oscillation in the oscillation direction determined by the oscillation direction determination unit.
